(19) United States
(12) Patent Application Publication
(10) Pub. No.: US 2004/0167989 A1
(43) Pub. Date: Aug. 26, 2004

(54) Method and system for creating and managing a website

(76) Inventors: Jeff Kline, Boca Raton, FL (US); Jeff Kasten, Boca Raton, FL (US); Mark Zeitler, Sarasota, FL (US)

Correspondence Address: EDWARDS & ANGELL, LLP, P.O. BOX 55874, BOSTON, MA, 02205, US

(21) Appl. No.: 10/700,814

(22) Filed: Nov. 4, 2003

Related U.S. Application Data
(60) Provisional application No. 60/449,890, filed on Feb. 25, 2003.

(51) Int. Cl. G06F 15/16

(52) U.S. Cl. 709/245; 709/218

(57) ABSTRACT

A method for creating and administering a website hosted on a server includes normalizing the data as it is entered on the server. The data is stored at the server and all of the data is tagged when stored on the server with the respective tag to convert the data to objects, having desired associated properties as defined by the tags. The tags are then linked to desired locations within the website. Information regarding potential authorized users is stored at the server. Upon accessing of the website, the server determines the aggregate user's rights and enables editing and administrative privileges to the user based upon those rights. The website also changes its appearance to indicate to the user which access rights are currently enabled.

### CROSS REFERENCE TO RELATED APPLICATION

This application claims priority to U.S. Provisional Patent Application No. 60/449,890, filed Feb. 25, 2003 entitled METHOD AND SYSTEM FOR CREATING AND MANAGING A WEBSITE.

### BACKGROUND OF THE INVENTION

1. Field of Invention

This invention is directed to a web hosting platform which allows for creation and management of the website at a variety of hierarchal levels, and for efficient maintenance and editing of the website, after creation, at a variety of hierarchal levels.

2. Background

With the explosion of the World Wide Web and the Internet, websites have become ubiquitous, and provide the main portal for interacting with third parties. In order to enable websites, a web host is required.

Early web hosting services primarily provided static page content and ancillary e-mail services. However, as the world wide web became more accessible to greater numbers of users, both commercial and individual, out of necessity, the websites themselves became dynamic. In other words, the content of the web pages changed depending on user actions or over time. Web hosts, out of necessity, enabled these dynamic websites. The tasks became automated by the program language itself; languages such as Perl and PHP. PHP is a language that can be imbedded directly into the raw hypertext markup language (html) used to create documents and the format of the web pages themselves on the world wide web. As a result, design and code maintenance was made much simpler and faster for the web host.

With dynamic web pages came databases to support the web page. To facilitate widespread use of databases, the web hosts rapidly standardized the databases. Several databases now exist such as MySQL, mSQL-2, Postgres SQL and DB2 Microsoft SQL Server and Oracle for very large data intensive sites.

Furthermore, as the use of dynamic sites and data progress, more sophisticated, yet manageable applications were required to meet the demand for websites, website use, and the data thereon. Platforms such as ASP, DOT, NET, JAVA and JSP were developed. However, these applications were primarily developed for web host customers having large demand for use and an ability to defray the high cost of such applications, which were much higher than those costs associated with Perl and PHP enabled sites.

As hosting technology improved, so did the tools for producing content. One such tool is commonly known as What You See Is What You Get (WYSIWYG) editor, which allows for the rapid creation, sometimes in real time, of web pages. Two such WYSIWYG editors are Microsoft FrontPage and Macromedia Dreamweaver. However, these products are not capable of producing interactive, data-driven sites without significant programming knowledge on the part of the editor. Furthermore, once sites are produced making use of known WYSIWYG programs, specialized knowledge is required in order to maintain them. As a result, websites, which include rich, dynamic content, are expensive to produce, have significant bar to accessibility (knowing the specific code of the site) and represent a significant and ongoing resource commitment.

Given the complexity and size of the data and applications required to support most websites, module hierarchies have been developed as is known in the art. These modules may include database which allow website administrators to create lists and attach information about each element on the list, so that a website user can “click through” to the desired database, to the desired element within the database and then the associated information of interest. Another module may be an events calendar, which will be used by way of example throughout this application, which lets website administrators create a calendar of events and activities to be presented at the website. Each event will have information such as the date, time and other pertinent information such as location or sponsor about the event. Visitors to the website can view events by month, week or day, or access the event by clicking the day of the month on the calendar to view those events that occur only on that day. Once events have been added to the site, the website administrator (webmaster) can edit and delete events to ensure they remain current, or use the WYSIWYG editor to format the event information, to add pictures or other descriptive information. Furthermore, the events can be organized by category so that the webmaster can maintain the events in a group of related events together.

Other modules that are known are the web page module which allows webmasters and site designers to create new pages on the website. A file manager lets the webmaster or site designer upload and organize documents, pictures, spreadsheets, newsletters and other files to the website and then incorporate these files into the other modules. Broadcast e-mail modules allow the site designer to send e-mail messages to groups of e-mail addresses that have been stored and maintained through the website. A forms module allows interactive submission of information by the website user for the benefit of the owner. Modules may also accommodate banner ads, or commerce at an e-store such as the shopping cart and credit card processing. The modules may also facilitate the use of menus or lists. Modules may even help control the configuration of the entire website or the security of the website as well as the WYSIWYG editor, which in and of itself may be a module.

With the complexity and widespread adoption of websites, dynamic websites, the databases and applications required to support dynamic websites, a hierarchy of website development, maintenance and management has evolved. Each of the entities within the hierarchy has specific and sometimes conflicting needs. There are several key entities involved in the web hosting and management process in what will be referred to as the descending hierarchal order through this application, they are as follows:

a. Hosting provider—provides the basic infrastructure for the hosted website such as database support, storage capacity, bandwidth and the like. Hosting providers face the contradictory issues of providing the most up-to-date technologies and applications at the website at the lowest cost. Otherwise, they face the inevitable loss of clientele to either more dynamic website providers or lower cost website providers.

b. Reseller—Because of the scale of the websites which are hosted, most hosting providers have a well-developed reseller channel. These resellers may themselves have sub-resellers. Resellers provide value-added services, such as design services, technical support, or a local point of contact for the site owner or webmaster to address web-related issues. The reseller may also be the webmaster or site designer (see below).

c. Site Designer—The entity that initially designs the look and feel of the site (as compared to the webmaster below who is responsible for the ongoing maintenance of the site). They are those entities having the technical skill to master complex programming language and functionality to initially design the aspects of the site from interactive interfaces, to dynamic presentation, to the construction of the databases and the like.

d. Webmaster—Maintains and edits the content on the site once it has been designed.

e. Owner—is the entity which actually owns the website and whose name is associated with the website, i.e. it is the party for whom the website acts as the Internet portal to their goods, services and information. Converse to the concerns of the hosting provider, the web site owner wishes for the site to serve its particular purpose (provide information, generate revenue, gather information) for its end users in an attractive, efficient and technology advanced manner at least cost. The owner of the website wishes for the website to evolve over time as its own needs and the needs of the user evolve, requiring consistent modification to the website by the webmaster. Often the owner acts as the webmaster and sometimes the site designer. Furthermore, the owner is uninterested in any conflicting interests between the hosting provider, reseller, site designer and webmaster or any difficulties arranging for all to interact with each other.

f. Users—those entities who wish to make use of the website in order to get information they require, purchase goods or services, or to provide information to the owner. Not only do users require that these functions be done as easily as possible for the user, but they wish to be entertained or at the least enjoy their use of the website. Again, the user, like the owner, is concerned with ease of use, latest technology and low expense, whether measured time, money or aggravation.

Furthermore, despite their sometimes conflicting goals, each of these entities interact during the website creation process, the website use process, the website maintenance process, and the website update process. However, except for at very large organizations, these are distinct individuals, often utilizing isolated systems for a variety of reasons, and there is no way for these entities to interact in a meaningful way to most efficiently manage the system. They often rely on data from downstream, going up, when information is required. By way of example, the web host does not have access to the website itself, in most cases, to monitor web access (hits), to monitor changes to the website, or even to effect changes to the website in real time.

Accordingly, a web hosting platform which allows efficient interaction between the key entities and real time maintenance and editing of the website, even by those not fully skilled in complex database structure or website programming languages is desired.

It is desired that a platform independent methodology and process be developed to allow such operation and performance of websites at all levels within the hierarchy.

### SUMMARY OF THE INVENTION

A method and system for creating and monitoring a website stored on a third party server normalizes the data as it is entered on the server. The data is then stored on the server. All of the data stored on the server is tagged with a respective tag to convert the data to objects having desired associated properties as defined by the tags. The tags are linked to desired locations within the website to enable the website to operate on the information as defined by the tags.

To edit the website, the website is accessed from a remote location. Information regarding the user is stored at the server and compared with information about the user at login. The server, by comparing the information, determines the access rights of the user based upon the access rights information stored at the server. The server aggregates the user's rights and causes enabling icons corresponding to the access rights to be displayed at the website for the user to edit or administer the website.

In a preferred embodiment, all users with common access rights are grouped. The group and its access rights are stored at the server so that the server determines to which group the user belongs and enables the access rights based upon the rights of that group.

The server determines a hierarchal level of the user. The server provides an indicator at the website page to the user of their hierarchal level. In a preferred embodiment, the indicator is a color displayed on a significant portion of the website page, the color corresponding to the access rights of the user, the group of the user, or a status within a predetermined hierarchy.

### BRIEF DESCRIPTION OF THE DRAWINGS

For a fuller understanding of the invention, reference is had to the following description taken in connection with the accompanying drawings in which:

FIG. 1 is a block diagram of the interrelationship of system users and web hosts in accordance with the invention;

FIG. 2 is a flow chart for defining and tagging objects in accordance with the invention;

FIG. 3 is a screenshot of an example of an object in accordance with the invention;

FIG. 4 is a screenshot of an example of data being formatted at entry in accordance with the invention;

FIG. 5 is a flow chart for defining the group/access rights of a system user in accordance with the invention;

FIG. 6 is a table of exemplary system users, mapped to their access rights in accordance with the invention;

FIG. 7 is a flow chart of a method for determining user access level in accordance with the invention; and

FIG. 8 is a flow chart for editing a website in accordance with the invention.

### DETAILED DESCRIPTION OF THE PREFERRED EMBODIMENTS

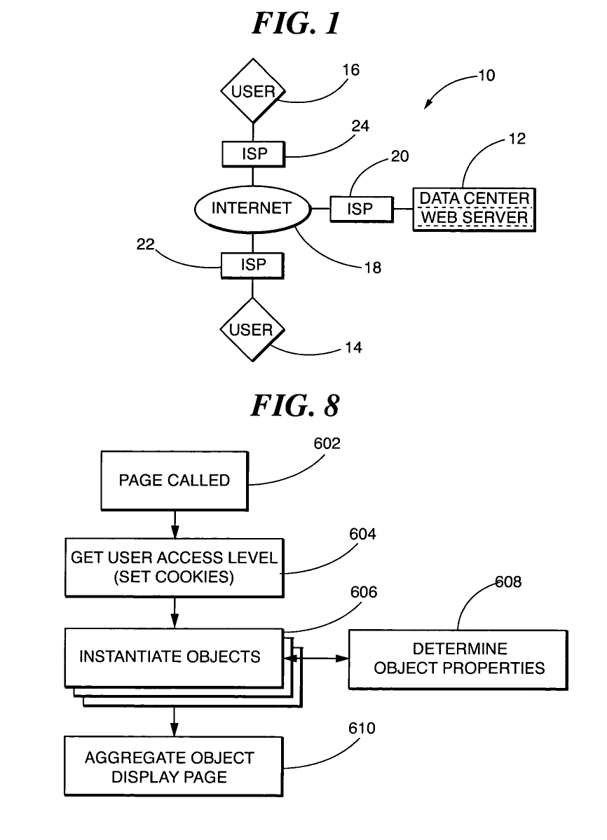

Reference is first made to FIG. 1 in which a system 10 includes a host provider/web server 12, which communicates with users 14, 16, utilizing conventional Internet-enabled computers, over the Internet 18 through respective Internet service providers (“ISPs”) 20, 22, 24. In this way, interactive communication between web server 12 and users 14, 16 is provided. The website itself and the databases and software therefore are stored at web server 12 which is the website host.

The invention is directed to a novel method for facilitating website design, maintenance and use for a website hosted at a third party site such as web server 12. Furthermore, the method and structure makes editing and maintenance of the web site possible utilizing software located solely at web server 12.

To facilitate and simplify the explanation, from here on in the examples of the operation and arrangement of the platform will be in connection with the creation, editing and maintenance of the calendar module. However, the explanations are easily applicable to any module utilized in the website.

The novel web hosting system is an object-oriented system that allows flexible and simple embedding and styling of objects via a web-based interface. Although web hosting systems have often taken advantage of the power of object oriented designs, it is has not been utilized to the extent or in the manner described below. In the present application, objects (which may themselves be made up of other objects) represent the entire site. However, users can make use of the objects via a simple web based interface, such as a commercially available browser by way of example, without the need for programming. Furthermore, objects may export different attributes or options to different users of the site, dependent upon their hierarchy in the web platform interface and, as a result, the objects are fully integrated with all parts of the site, including some management functionality.

One aspect of the system is the manner in which the data is entered. One challenge of maintaining a website is that the same information is often used in multiple places on the site. For example, if an event is used in a job module as well as a calendar module, the common practice on websites is to store the necessary data at both sites, therefore, editing of the website becomes complicated as editing of the data must occur in two distinct pages/areas of the website. The larger the website, and the greater the interrelationship of information among modules, the more difficult the task of maintaining the website becomes. The prior art approach has been to internalize the data at design time utilizing a web-authoring package, which compiles links between the data, or have server side code manage a virtual table of contents amongst related bits of data. However, such an approach is not practical for large sites with highly dynamic content. The process of removing or minimizing such data redundancy is known as normalization in the art.

In the present invention, all information that makes up the site is formatted to normalize the data. The content is formatted so that data as entered can be normalized and easily objectified as discussed below.

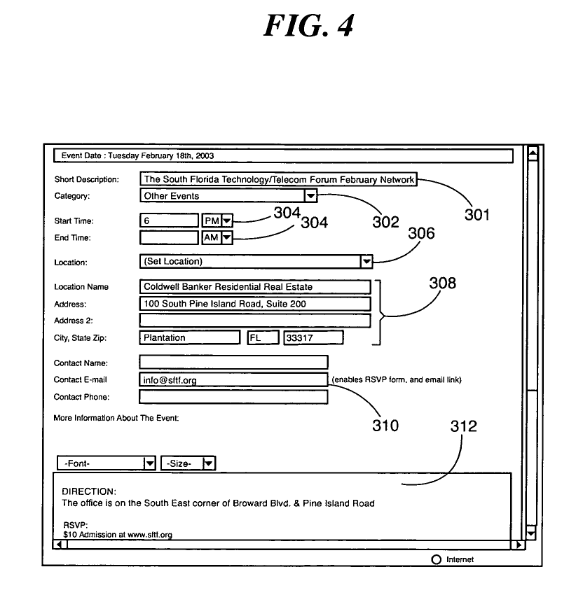

Reference is made to FIG. 4, which is a screenshot for entering fields of information in accordance with the invention. An event data is shown by way of example. However, the concept of entering data as predetermined fields lends itself to objectification of the data to facilitate tagging, as discussed below.

Within the platform, the screen shown in FIG. 4 is provided to a user for entering an event. A plurality of data entry fields, corresponding to a type of data, are provided. A first field 301 is a short description of the event itself, while field 302 may be a more advanced drop down field identifying the category of the event. Fields 304 are the start and end time of the event while fields 306, 308 are the address for the event. Field 310 can be a contact e-mail, which can be used to RSVP, through use of a hot link to the event sponsor. Where free text is required as opposed to the formatted standardized text, a miscellaneous field 312, which merely stores the data, which is not to be manipulated is provided.

As the data is entered, it is stored on server 12. Because it is entered with an associated field, server 12 recognizes the data content categories and applies necessary tags, associated with certain content as described below. This may be used for instructions, further descriptors, or the like. Some fields are required while others may be optional at the discretion of the system designer.

This strict formatting is different from a simple free text event field, which provides data, which is syntactically difficult for a computer to parse. However, through the use of formatted fields containing expected data in an expected format, the data lends itself to uniform objectification, i.e., the data can be easily turned into tagged objects as will be discussed below. As a result, the data is automatically generated into month per view or year per view calendars that are automatically updated when events for the underlying data are edited. Automatic alerts to certain registrants if certain attributes of an event are modified and normalization is a natural outflow as the event itself is treated as an object that is embedded into other places on the website as will be discussed.

An object exposes certain ways of interacting with it, however, the attributes or how the object works component are hidden from the programmer. As a result, the programmers use objects as building blocks for other more complex tasks enabling a high degree of code reuse and flexibility. Furthermore, if an object is updated, no work is required of programmers who have utilized such objects in their code provided that the external appearance of the object has not changed.

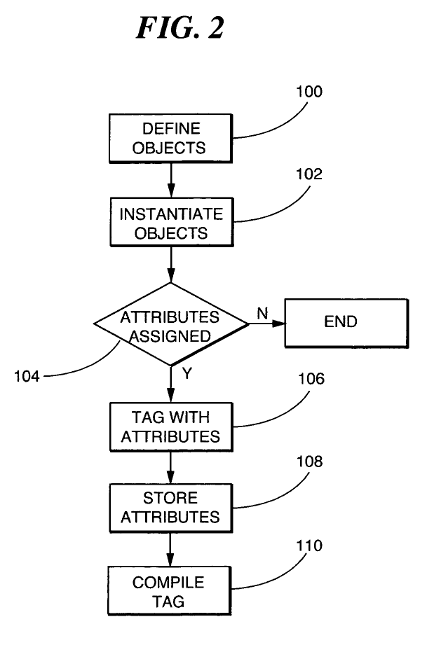

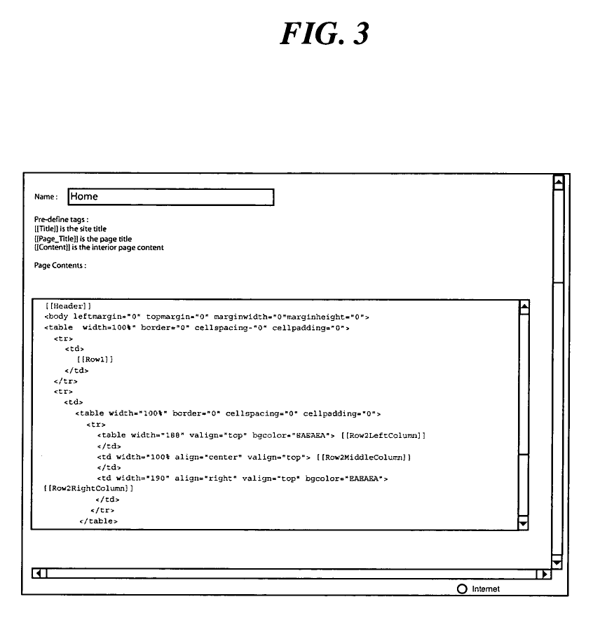

The present invention, as shown in FIG. 2, provides a platform, which applies the object structure, not just at code level as in prior art platforms, but also directly at a level web designers can use at the website design stage without the need to know the programming language. Objects are defined and named (tagged) within the system using a web-based design tool. The object can contain, but is not limited to, other objects defined by the user, embedded system objects, HTML, Java Script and VBScript, by way of example. Therefore, the data entered in the format discussed above is treated as distinct objects, which are defined and named in a first step 100. Once defined, these objects can be instantiated on a web page quickly and easily simply by including the tag name in a known language format into content, a style sheet, or a page template. By way of example, the tag name may be identified in double square brackets to indicate the object to be embedded. See FIG. 3. This is done in a step 102. In a step 104, it is determined whether or not attributes are to be assigned to the object. If not, then the operation on the object is ended. If it is determined that no attribute is to be assigned, the process moves on to either defining another object or performing another task.

If it is determined in step 104 that attributes are to be assigned to the object, then in a step 106 the object is tagged with attribute values. For example, for an object such as calendar, the process for embedding the object with values or rules may simply be to indicate that the calendar is an object created through the use of language by indicating that the calendar is an object utilizing double brackets on either side of the object as was discussed in step 100. However, if attributes were to be passed, for example, layout instructions or cross-linking instructions, then the entire attribute along with the object would be indicated by some language, for example, [[calendar attribute one=f00, attribute two=bar]]. This, for example, may indicate to a compiler that at runtime the object is being instantiated according to the rules for its display, such as spacing, color or the like. These attributes are stored in the host database in step 108 and the tag is compiled into usable language in step 110 so that it may be part of the output sent to the end user interfacing with the website. In the case of a regular web browser, these attributes may be in HTML. It should be noted that tags and data objects can be edited in real time after site design merely by editing the tag language or replacing the data which is the object of the tag.

In a more concrete example, end user 14 (FIG. 1), if enabled to edit a website, would log in to the website at host 12 over Internet 18. The user will be prompted with a tags interface. In a preferred embodiment this would be a graphical user interface icon, which could be selected utilizing a mouse or other input. The user would then be prompted to either modify an existing tag or to add a new tag.

If adding a new tag, as in step 100, the base object is selected. For example, a calendar object would be selected and named.

The platform would then display a form, which would describe the attributes and parameters available for this object. For example, in FIG. 3, tagged objects for the presentation of a homepage is shown with formatting for the objects of the homepage. In the case of the calendar example, the attributes and parameters could be month to view or two weeks to view. Once the parameters and attributes are set, as in step 106, the tag is stored in the database at host 12 in accordance with step 108 and compiled into website enabling languages such as PHP and HTML, by way of example. As a result, the platform generates the code required to handle the tag in step 110.

The tag can now be linked to desired locations within the website so that the object may be used anywhere desired throughout system 10. Whenever the tag is encountered by the compiler, the system displays the object as required. If an object is to be reused on multiple pages of a website, because the tag, and not the object, is what defines use of the object on an individual web page, editing of the object edits the use of that object throughout the system.

As can be seen, tags or objects can be used in multiple locations, but need only be stored once. By way of example, if a custom calendar object is required on several pages, such as the calendar page, an events page, an advertising page and the like, the object of the event itself need be defined only once and its tag is referenced on the page which requires the use of this new object. As opposed to the template approach commonly used on current websites, objects are free to interact at display time with each other and will display differently based upon the rights of the user and its own location on the page. By cross-linking tags, objects can in effect communicate with other objects on a page. Accordingly, when editing content that is internally synchronized, the two can operate and be maintained and edited together. By way of example, a calendar object is required to display information about a particular meeting, the key word for that meeting can be determined by an advertising object on the same page, allowing the calendar to target the advertising message at runtime.

Through the use of tags with the values and rules associated with the object, the object is self-contained, including its own information regarding how to edit it, store and render it. By defining objects and tagging them with values and then in fact tagging the tagged objects, all entities in the system are in fact objects, each of which is self-contained, including its own information regarding how to edit it, store it and render it. Thus, third party objects can be seamlessly integrated with the base system. By way of example, a calendar object must carry with it information concerning how the management system should render it and arrange it. Similarly, as all parts of the system need a particular interface requirement, it is easy to change the system, not just at a user or site level, but at management levels as well, as will be discussed below.

In a more granularized example, as the data for an event is tagged such that the day, month, year, hour, minute, duration, location are identified, the calendar object can identify the appropriate dates to highlight as containing events. In this case the tag of the event itself is in fact an object of the tagged calendar object. Thus, the system correctly renders the calendar at runtime by rendering the calendar in accordance with its attributes and the event within the calendar in accordance with its attributes. When an event viewer accesses the same data stream, it pulls from the different parts of the data to correctly render the event for the user. However, in both cases, the data is stored once and only once per event. The calendar and the event viewer use different mechanisms to render the data object of interest.

In terms of editing, the data object can be edited apart from the calendar object or the event view object. Thus, changes to the calendar and the event view display may be made from the single edit to the object of the actual event. As a result, data integrity is enhanced by preventing data redundancy and the need to edit in several places.

Furthermore, in normalizing external links and saving them as linked objects, it is possible to quickly and easily check that all external links on the site are working and available. Furthermore, if a link occurs in multiple pages, it only needs to be stored once in the database, thus, if the link becomes outdated, this link only needs to be changed in one location to be displayed correctly wherever it is referenced.

A number of users in the Internet hierarchy need to access the website at web server 12 to perform functions. Often the function performed at the website is greatly different amongst the position in the hierarchy at which the current user resides. The end user of a website is only concerned with the interactivity of the website and how information is transferred back and forth, while the web host may be concerned with the number of overall hits across a number of websites which it is hosting, as well as the operation of a particular website and even the experience of that end user at a particular website. The web host in performing its maintenance and support function to the website may, in fact, need to mimic the end user, web designer, webmaster or any other functionality of the chain. However, it is sometimes difficult for the webmaster or any intermediary level of the website hierarchy to keep track of where in the hierarchy they are or what access rights they may have.

Much like the hierarchy discussed above, one aspect of the platform is to divide the various users of the website by functionality levels. Functionality levels are dictated by the access and rights provided at that level. As will be determined below, in accordance with the invention, access and rights can be granularized to the point where a level may consist of a single member having a unique combination of access rights and powers. Furthermore, each level is associated with an indicator, which indicates to the user the level in which they are operating. In the preferred example, the indicator is screen color, either the background or a significant portion of the screen, so that it is a color associated with that level of interface and the features to which the user has access and control. As a result, the color theme of a particular level represents the role of the user currently serving on the website. Thus a user seeing a red interface is clearly in the red (server administrator) on the site. Similarly, a user who sees a blue interface is unmistakably operating in the capacity of blue (site administration). Individual users may exist in one or more of these color-coded levels. That is a user may have one or more roles on a particular site and may elect to observe and operate within the site at a desired level, not corresponding to its full access rights and powers. In this way, control of the website is distributed to those whom are best able to maintain the relevant information regardless of their technical ability.

In the preferred embodiment, each of the color-coded interfaces or levels represents a particular user role within the website. By way of example, these are:

First Interface (WHITE) (Website Visitor)—a WHITE interface is any code or user interface that touches the end user. This is traditionally known as the standard web presence or the end user interface. The end user only has access rights to download content or provide content and can not to affect the operation, appearance or any other features of the website. This user is often presented with a WHITE theme or background.

Second interface (BLUE) (Website Owner/Administrator)—the BLUE interface allows the web content administrator to dynamically change the content of the WHITE interface of the site by accessing content resources they are authorized to access. These may include events to populate the calendar and other modules, news articles, web pages, FAQs, polls, linking of banner ads, etc.

It should be understood that while the website owner is acting as the administrator to change content of the presented website would be BLUE. However, if authorized, the website owner could enter the website as an end user to confirm the content changes made and the background or theme of the website would be WHITE indicating that the operator no longer could edit, but was interacting as all other end users at the first interface.

Third Interface (GREEN) (Designer of website)—the GREEN interface allows the web designer to change the configuration, setup and look and feel of the site, in contrast to changing the content at the BLUE/third interface. The web designer usually has full control over the appearance of the site, by way of example, the designer controls the actual code and structure of the page as presented to end users. However, it should be noted that the GREEN interface can be and, in a preferred embodiment is, enabled to configure and control many of the features and capabilities contained in the rights and powers of the BLUE interface.

Fourth Interface (SILVER) (Intranet access)—the SILVER interface is used by end users of an Intranet platform to access e-mail, schedule meetings, save files and virtual desktops. In a preferred example, it is the groupware, and is used by the users who usually have BLUE access rights or Internet websites.

Fifth Interface (PURPLE) (Website Owner)—the PURPLE interface allows the website owner to control and configure the websites and software installed on the server. For example, server software may include Apache, MySQL, PHP and/or the website platform. A website owner may use PURPLE to administer or modify the configuration settings for one or more websites supported by the platform. The website owner would know that these features are available as the predominant interface color would be PURPLE.

Sixth Interface (RED) (Distributor of website/host provider)—the RED interface is used by the web development company to administer and monitor multiple sites from a single control panel. The RED interface can also be used for storing and managing customer billing information and account information and may not necessarily come with the rights of the GREEN, BLUE and SILVER interfaces.

Seventh Interface (BLACK) (Master Distributor of Websites)—the BLACK interface is used to track, bill and manage a large number of website installations. This may correspond to the master reseller or the web host. In addition to this, the BLACK interface also manages the features available to RED and other lower levels of the hierarchy. The background or prevalent color at this level would be BLACK.

Eighth Interface (GOLD) (Source Code Software Server)—the GOLD interface stores the master source code for the software platform and allows modification and administration of the entire hierarchy. The GOLD platform releases new source code for site/server upgrades and new installations. By the entry color when in the interface, the user would realize they were in the eighth interface by the GOLD background color

It should be noted that these colors are selected by way of example only. What is the common denominator of this aspect of the invention is that the hierarchy of levels is associated with a distinctive, easily memorable and highly identifiable marker, such as color. However, graphics such as designs and fonts or sounds such as music could also be used to indicate the current access level. As a result, system management is accomplished using a memorable, powerful and simple tool for indicating to a higher level user in which level they are operating. It aids in management of the system as a whole.

One aspect of the invention is that access to particular levels and the powers associated with those levels can be assigned by a user at a level above the interface of the current user. Therefore, in a preferred example, any user at a particular level, if enabled by the user at the level above them, can provide themselves with the access and power of each interface/level below them. Note that the hierarchy is not necessarily a simple hierarchy of the form A>B>C>D, but is a tree hierarchy such as A>B, A>C, C>D, but perhaps B not >D.

Access and power are mapped to user ID and groups. For example, a user who is a site developer and therefore a member of the GREEN interface is given extremely powerful access and power rights. Therefore, it is not recommended to provide the full powers of the GREEN interface to a content administrator; more likely to be given the powers of the BLUE interface. However, there are certain functions in the GREEN interface that an administrator may wish to grant to the content administrator. As a result of the present platform, a highly granular access control system is incorporated so that specific subsets of functions for each interface level can be granted to other users of the system. Because configurations, features and options displayed by lower privileged levels can be controlled by higher level user interfaces as enabled and stored at the server, granularization of the various access rights is provided and no specific client-side software except a conventional web browser is required. The granularity of the system is a result of control of the access at group levels.

It is possible to create a group of users and assign rights based upon that group. Thus, anyone in a particular group will be extended the access rights granted to that particular group. Rights are added such that a user in multiple groups has access to the combined rights of the group they are in. This access can be granted at the user level, as it is possible to assign access rights to a particular group and then put only one user in it. In other words, a group of one with a collection of rights assigned to only that one individual is created.

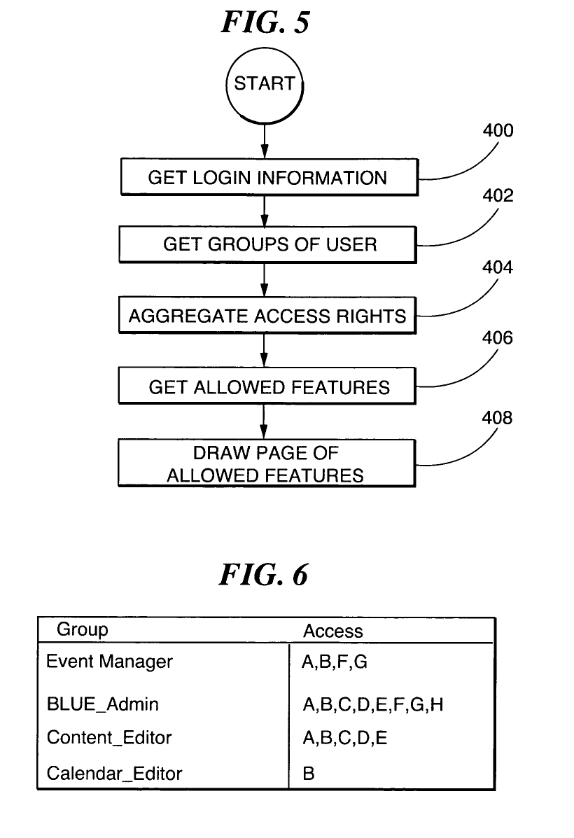

Reference is now made to FIG. 5 where a flow chart for determining group/access is provided. A user 14, 16 logs in to the web server 12 across Internet 18 in order to access the website. Web server 12 in a step 400, under software control, obtains the login information from the user. It should be noted that, in a preferred embodiment, any entity from the website owner (second interface) through the host server (eighth interface) can assign access rights to lower level users and map these access rights to the user ID and/or other password and store this mapped information at web server 12. However, an embodiment in which only specific users can grant rights is also contemplated. In the preferred embodiment, if no access rights are provided, then the user will be unable to log into the website or will be automatically defaulted to the first interface level as a website visitor if in fact it is a public website. If this is the first access at step 400, the server 12 determines which rights of access are being granted to the user and the user will be assigned a group corresponding to those rights even if it is a group of one; the individual user themselves. In step 402, based upon the login information, the appropriate user group corresponding to the user will be recalled.

The aggregate access rights corresponding to that group of users as stored at server 12 will then be enabled by server 12 in step 404. The access rights are aggregated in step 404, the allowed features corresponding to those rights are determined at server 12 in step 406 and in step 408 the enabling icons of the features will then be displayed on the access page at which the user is logged in. In step 408, when a user is accessing a user interface that is specific to their color-coded access level, or the access level with which they are interfacing, server 12 renders an indicator of the effective level of the pages created. For example, if a BLUE user is using a WHITE specific page, such as viewing the calendar module, the visual indicator indicates the WHITE user level by displaying a WHITE background or other WHITE theme. However, if the user then access a BLUE-specific page through an enabling icon, such as an icon for editing the content of the calendar, the visual indicator will indicate of the user's currently functioning level which would be BLUE.

The different features can best demonstrate the various different privileges of users that a user may have access to in each of the color-coded levels. By way of example, with respect to the calendar object, if the user is in the WHITE user level (regular or end-web user), the calendar will display a series of dates in a site-specific manner, highlighting dates that have specific events. If the user were in the second interface, BLUE user group (content editor), the user would then have additional rights associated with the BLUE user group at the calendar object. For example, in addition to being able to access the features of the calendar, as would a WHITE interface user, the BLUE user may add new events or edit existing events and content pointed to by the calendar. Thus, the calendar is rendered differently if the system detects a user with calendar edit rights.

If the user is in the GREEN user group (site designer), the user will have the same rights as the WHITE user with the addition of being able to modify the display style of the calendar, such as, for example, change the font of the events, the layout of the calendar objects. Other features and options are similarly available for other color-coded levels of the site along the hierarchy.

In addition to this type of feature control, users can be granted custom rights to objects through their color-coded level. For example, all BLUE users may have certain rights or via a group, for example, all BLUE users may or may not have access to a particular feature. One particular group of users within the BLUE level can be allowed access to a single feature while others may not.

A user may be assigned to a group or given specific access rights by an administrator at a level higher than their own by storing a user ID and associated group at server 12. By way of example, as shown in FIG. 6 within the same BLUE level one may have an event manager, a BLUE administrator, a content editor and a calendar editor. Each of these requires different access levels to perform their functions. They may all need one specific function to perform their job, such as access to the calendar itself. So, for example, as in FIG. 6, if the user were the content editor, the user would have access to resources A, B, C, D and E. In contrast, only the administrator for the entire BLUE interface has all the BLUE interface powers. Conversely, a user who is in the BLUE interface level and a member of just the calendar editor group would only have access to resource B, such as the calendar itself. This may be a limited member of the BLUE group, or a member of the GREEN or PURPLE interface who has been granted an additional access right at the BLUE level.

The above example is made for the respective differentiated users at one access level within the hierarchy. However, the system works in an analogous manner with respect to access rights for users at various levels within the hierarchy. For example, a RED administrator will have access rights if assigned at initialization as discussed above, to resources A-H as well as the functionalities and resources of I-Z or whatever other resources are necessary to perform its function.

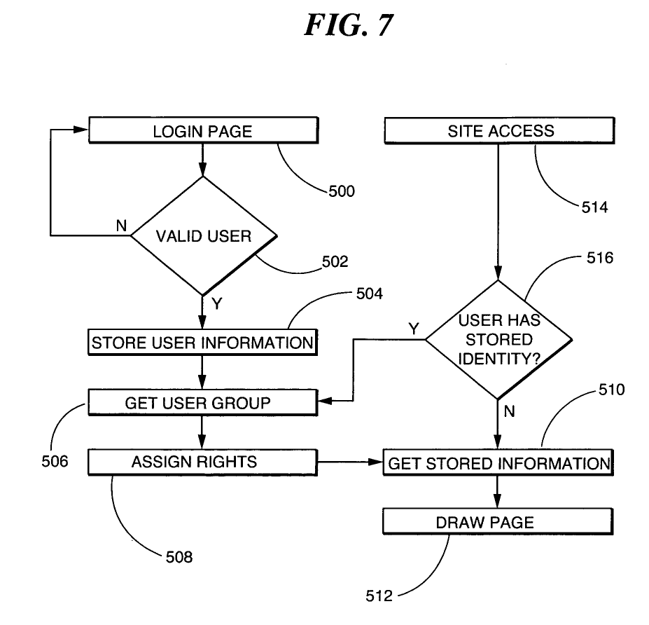

Another aspect of the invention is that a user can enter the website at server 12, one of several different ways as shown in FIG. 7. For example, consider the case of a first interface WHITE level user 14 as compared to a higher level such as BLUE user 16. Each user can enter the site one of several different ways. For example, user 16 may log in at the BLUE user interface via a site log in screen in accordance with a step 500, located at a particular URL. When entering the site this way, the user is taken directly to the BLUE administrative control screen from which the features available to a BLUE user are displayed. First interface WHITE user 14 would be unable to access the BLUE screen at the site access as it would not be recognized or enabled for such access as discussed above when user 14's group is called from server 12. However, both may access the site directly through its public interface, the first interface level, or by any other interfaces to which the user may have been granted access that are lower in the color hierarchy if in fact such rights have been granted.

In the example in which the user accesses the system at a login page according to the interface level, RED may have one login address, while a BLUE interface user would have another. A login is conducted in a step 500. In accordance with step 502, it is determined whether or not a valid user has logged in at that address. If not, the user will be returned to the login page. A message will be displayed at the login page that that person does not have access rights for that login level. This is done by comparing the login information at the login page to the groups of users determined and stored at server 12 in the process of FIG. 5. If the user is valid as determined in step 502, the user information is stored either temporarily or permanently on the system in step 504 and the user group is retrieved in step 506. The access rights corresponding to that group as stored at server 12 are then brought up in accordance with step 508. In step 510, the server, in response to the access group information, brings up information accessible by the user at the user's level. The information forms the page, which is displayed in step 512 with the appropriate enabled icons for a user of the level, which has logged in.

In the alternative, because the access rights of each user are in fact stored on server 12, a user can access the rights at any level below their highest authorization within the hierarchies. By way of example, in a preferred embodiment, a RED or GREEN interface user can access the site at the WHITE or at the BLUE interface levels. Accordingly, if an administrative user is monitoring the web page at the end user level (WHITE interface) in accordance with step 514, server 12 will compare the identity from the log on information or cookies or other ID information to its user information in step 516. If recognized, i.e., the user has a stored identity, then the process is repeated from step 506 and the user group information and associated rights are retrieved. If the user does not have a stored identity and therefore an assigned group, by default it will only be shown stored information available for public viewing, without the right to manipulate the information at the website in step 510, in other words, a WHITE level user by default.

By use of this system, a BLUE level user may still edit the website at the WHITE interface level. For example, if a BLUE user enters the site at site access in step 514 and the user has been identified as a BLUE level user, content edit icons will appear at the white interface level and BLUE level access will not be granted until the edit icon has been selected.

As a result of the assignment of hierarchal access rights and powers, and the object orientation of all elements of the website stored at the server, it is possible to edit the content on the website from any location within the website to the extent allowed at the associated interface levels without the installation of client-side software.

Reference is now made to FIG. 8 in which the process for editing the website is provided. Once a user has logged in at the appropriate access level, they will call a page, i.e., select a page of interest at the website in accordance with step 602. The server utilizing a user-site cookie, session-specific variable or a transient cookie at the user side tracks the access and power rights of the user during each session. Based upon this information, the server 12 will enable the user access level rights for that particular page of interest in step 604. If the system determines that the user has rights to edit the content (BLUE level interface) or the layout (GREEN level interface), or some other higher level for the object in interest, the user will be supplied with an edit icon or other enabling graphical user interface. In the preferred embodiment, an edit button is displayed on the page. Selection of the icon will present the user with a second page allowing that user to edit the content or object that was previously displayed. This may be done, as known in the art, by way of example, by selecting that portion of the content or layout to be edited by highlighting the portion to be edited with a mouse or other user interface. As a result, the edit function goes directly to the object to be edited. A screen much like that shown in FIG. 3 will be presented and the object or tag may be edited.

Because of the high degree of object tagging discussed above, the edit to the underlying object is carried throughout the website. Furthermore, because the user access level is determined by server 12 from the user ID, cookies or the like, the access level for that user is determined no matter how the site was entered so that a particular user at a particular level is enabled to edit anywhere on the website for which they have rights from any log in level.

It is noted that the indication of the ability to edit may take several different forms. For example, if a page consists of multiple objects, each object may offer its own edit button, there may be a general edit button for the main content of the page, a single object may have zero or more edit buttons, depending upon the data being edited and the rights thereto, or graphically indicating a specific object and selecting that object will automatically cause editing of the selected object. For example, if a calendar object is to be edited, there may be one edit button for the calendar objects on this page such as events to be displayed, an edit button that edits only the event currently being displayed by the calendar object or an edit button for global calendar formatting options.

Once an object is selected or instantiated in a step 606, the server 12 then determines the object properties 608 from its tags. The aggregate object is displayed in a step 16 for editing. In step 608, the object properties for that particular user are aggregated and instantiated so that each object configures itself appropriately for the rights of the user. In step 608 server 12 compares all of the object properties to those which are under the access and power rights of that user, and it is that which is instantiated and aggregated for display in step 610.

As a result of the ability to allow editing from anywhere and to change the desired object, the website can be easily maintained by any authorized user. Furthermore, the editing user does not need to change modes or log into any special editing mode while viewing the site. The edit function can be invoked from the regular site interface, even as low as the WHITE level for those having the proper access rights. This is done because the user's credentials are automatically tracked on the server once they have logged in. Furthermore, the editor does not need to locate the content to be edited as they are taken directly to that particular content or page immediately upon selection of the edit. Furthermore, complete access to the site is not needed, as the content editor's options can be strictly limited based upon the access privileges. This granularity can be data field by data field so that as a result of the inherent tight control, accidental or inadvertent editing by non-authorized users cannot occur. The editor cannot overstep its access rules.

Lastly, the system can determine and track edits and archive the edits and information about the edit. Because server 12 is a control on how content and design is modified on the site, whenever content editing is invoked, the system is aware of the user making the edit. When the content edit functionality is invoked, server 12 can record the date, time and even the changes made to the site, along with the corresponding user ID, plus additional information. This is the fallout of the tight control.

By making use of the features above, designers can provide significant value-add to the owner of the website. As a result, more advanced page customization, combining click-to-build and raw HTML editing, style sheet generation and the ability to embed custom objects result. Additionally, users with different access rights in the hierarchy can interface the system at a variety of interface levels to control editing of the website and maintenance of the website as permitted. In this way, editing of the site is limited to those users best able to make the edits regardless of technical ability.

An important aspect of the system is shifting the most time-consuming part of building a website, generating and maintaining the content to the end user themselves which allows resellers and host providers to maintain control of the process. It allows the server to maintain control while giving important functionality to users not as technically inclined as the reseller and server staff.

Although a specific embodiment of the present invention has been described in detail herein with reference to the accompanying drawings, it is to be understood that the invention is not limited to that precise embodiment and that various changes and modifications may be effected therein by one skilled in the art without departing from the spirit and scope of the invention as defined in the appended claims.

What is claimed is:

1. A method for creating a website on a server comprising the steps of:
normalizing data as it is entered on the server;
storing the data at the server;
tagging all the data stored on the server to convert the data to objects having desired associated properties as defined by the tags; and
linking each of the tags to desired locations within the website.

2. The method of claim 1, wherein at least a first tag associated with a first data is cross-linked with at least a second tag associated with a second data.

3. The method of claim 1, wherein normalizing the data includes the steps of:
presenting a template to a user, said template being formed of a plurality of fields, each of the fields corresponding to a type of information; and
the data corresponding to a respective type of information being entered in the field corresponding to the type of information.

4. The method of claim 1, wherein a first tag is linked to more than one location within the website, further comprising the step of editing the website at a plurality of locations by editing the data associated with the first tag.

5. The method of claim 1, further comprising the steps of assigning access rights to the user, storing the access rights at the server, and providing icons at the website to enable editing of the website, a respective icon corresponding to a particular editing function determined as a function of the access rights assigned to the user.

6. The method of claim 1, further comprising the step of editing the website by editing at least one of the tags associated with data.

7. A method for administering a website wherein the website is hosted at a server comprising the steps of:
accessing a website by a user;
determining a hierarchal level of the user; and
providing an indicator to the user of the hierarchal level at which they have accessed the website at the website page.

8. The method of claim 7, wherein said indicator is a graphical indicator.

9. The method of claim 8, wherein the graphical indicator is the color of a significant portion of the website as displayed to the user, said color corresponding to the hierarchal level of the user.

10. The method of claim 7, further comprising the steps of:
storing the hierarchal level of the user at the server;
allowing the user to enter said website at a different hierarchal level than that stored at the server; and
providing a second indicator corresponding to the hierarchal level of the user corresponding to the level of which the user has accessed the website.

11. A method for administration of a website hosted at a remote server comprising the steps of:
accessing the website;
obtaining login information from the user;
determining at the remote server the access rights of the user based upon access rights information stored at the remote server;
aggregating the rights of the user; and
displaying enabling icons at the website corresponding to said aggregated access rights for said user.

12. The method of claim 11, further comprising the step of grouping all users with common access rights into a plurality of respective groups and storing the groups at the server, determining to which group the user belongs, and enabling the access rights for the user based upon the rights granted to the group to which the user belongs.

13. The method of claim 11, further comprising the steps of determining a hierarchal level of the user and providing an indicator to the user of the hierarchal level of the user at the website.

14. The method of claim 13, wherein the user accesses the website at an address corresponding to a hierarchal level, and the indicator indicates the hierarchal level corresponding to the address.

15. The method of claim 11, further comprising the step of accessing the website at an address corresponding to a predetermined access right.

16. The method of claim 15, further comprising the steps of determining whether a user is authorized for access at the address corresponding to the predetermined access rights utilizing the access right information stored at the remote server and, if authorized, aggregating the rights of the user.

17. The method of claim 16, further comprising the steps of:
grouping all users with common access rights in respective groups;
storing the respective groups at the server;
determining to which group the user belongs; and
aggregating the rights based upon the rights associated with the specific group to which the user is a member.

18. The method of claim 11, further comprising the step of accessing the website at a public address, determining whether any access rights for a user accessing the website at the public address have been stored, and displaying no icons at said website for said user when no access rights have been stored at the server for said user.

19. The method of claim 11, wherein said icons enable editing of material on the website.

20. The method of claim 11, further comprising the steps of:
determining a hierarchal level of the user as a function of the rights of the user, and providing an indicator to the user of the hierarchal level of the user.

21. The method of claim 20, further comprising the steps of:
storing the hierarchal level of the user at the server;
allowing the user to enter said website at a different hierarchal level than that stored at the server; and
providing a second indicator corresponding to the hierarchal level of the user corresponding to the level of which the user has accessed the website.

22. A system for administration of a website, said website having a plurality of locations within the website comprising:
a server for storing the data for the website;
an input for normalizing the data as it is entered into the system for storage at the server; and
at least one respective tag being associated with each respective data stored on the server to convert the data to objects having desired associated properties as defined by the tags, said tags being linked to desired locations at the website.

23. The system of claim 22, wherein at least a first tag associated with a first respective data is linked to at least a second tag associated with a respective second data.

24. The system of claim 23, further comprising a computer displaying an input screen, said input screen having at least one preformatted field, a respective preformatted field corresponding to a data type to normalize the data.

25. The system of claim 23, further comprising a plurality of icons displayed at said website, the icons corresponding to a particular type of editing function, the display of such icon being determined as a function of information about the user stored at the server.

26. A system for administration of a website comprising:
a server, the server storing data for the website and access rights information for system users;
an internet access for accessing the server by a user, the server obtaining login information from the user through the internet access, and determining the access rights of the server based upon the user access right information, and aggregating the rights of the user; and
icons displayed at the website for enabling the user to interface with the website in accordance with said aggregated access rights.

27. The system of claim 26, wherein the user access right information is stored in groups of users with common access rights, the server enabling the access rights for the user based upon the rights granted to the group to which the user belongs.

28. The system of claim 26, further comprising an indicator displayed at the website to indicate a hierarchal level of the user at the user interface.
